(19) United States
(12) Patent Application Publication
(10) Pub. No.: US 2010/0061346 A1
(43) Pub. Date: Mar. 11, 2010

(54) CHANNEL QUALITY FEEDBACK SIGNAL FOR WIRELESS NETWORKS

(75) Inventors: Shu-Shaw Wang, Arlington, TX (US); Kyeongjin Kim, Irving, TX (US); Shaohua Li, Beijing (CN); Xin Qi, Beijing (CN)

Correspondence Address: BRAKE HUGHES BELLERMANN LLP, c/o CPA Global, P.O. BOX 52050, MINNEAPOLIS, MN, 55402, US

(73) Assignee: Nokia Siemens Networks Oy, Espoo (FI)

(21) Appl. No.: 12/211,289

(22) Filed: Sep. 16, 2008

Related U.S. Application Data
(63) Continuation-in-part of application No. 12/205,663, filed on Sep. 5, 2008.

(51) Int. Cl. H04J 3/00; H04W 24/10; H04B 7/216

(52) U.S. Cl. 370/336; 455/423; 370/335

(57) ABSTRACT

According to an example embodiment, a method may include broadcasting, in a downlink direction to one or more mobile stations in a wireless network, a message that includes a channel quality threshold, and receiving a signal from at least one of the one or more mobile stations, the signal being received in an uplink direction on one or more resource blocks that have a channel quality, as measured by one of the one or more mobile station in a downlink direction, that is greater than or equal to the channel quality threshold.

### CROSS-REFERENCE TO RELATED APPLICATIONS

This application is a continuation-in-part application of U.S. application Ser. No. 12/205,663, filed on Sep. 5, 2008, entitled “OPPORTUNISTIC UPLINK FEEDBACK SCHEME FOR MU-MIMO SYSTEMS,” hereby incorporated by reference in its entirety.

### TECHNICAL FIELD

This description relates to communications, and more specifically to the feedback of communication channel condition information and the allocation of resources based, in part, upon the information feedback.

### BACKGROUND

Worldwide Interoperability for Microwave Access (WiMAX) is a telecommunications technology often aimed at providing wireless data over long distances (e.g., kilometers) in a variety of ways, from point-to-point links to full mobile cellular type access. A network based upon WiMAX is occasionally also called a Wireless Metropolitan Access Network (WirelessMAN or WMAN); although, it is understood that WMANs may include protocols other than WiMAX. WiMAX often includes a network that is substantially in compliance with the IEEE 802.16 standards, their derivatives, or predecessors (hereafter, “the 802.16 standard”). Institute of Electrical and Electronics Engineers, IEEE Standard for Local and Metropolitan Area Networks, Part 16, IEEE Std. 802.16-2004.

One particular derivative of the 802.16 standard is the, as yet finished, 802.16m standard that attempts to increase the data rate of wireless transmissions to 1 Gbps while maintaining backwards compatibility with older networks. IEEE 802.16 Broadband Wireless Access Working Group, IEEE 802.16m System Requirements, Oct. 19, 2007.

Wireless Local Area Network (WLAN) is a telecommunications technology often aimed at providing wireless data over shorter distances (e.g., meters or tens of meters) in a variety of ways, from point-to-point links to full mobile cellular type access. A network based upon the WLAN standard is occasionally also referred to by the common or marketing name “WiFi” (or “Wi-Fi”) from Wireless Fidelity; although it is understood that WLAN may include other shorter ranged technologies. WiFi often includes a network that is substantially in compliance with the IEEE 802.11 standards, their derivatives, or predecessors (hereafter, “the 802.11 standard”). Institute of Electrical and Electronics Engineers, IEEE Standard for Information Technology—Telecommunications and Information Exchange between Systems—Local and Metropolitan Area Network—Specific Requirements—Part 11: Wireless LAN Medium Access Control (MAC) and Physical Layer (PHY) Specifications, IEEE Std. 802.11-2007.

Multiple-input and multiple-output (MIMO), is generally the use of multiple antennas at both a transmitter and a receiver to improve communication performance. It is often considered one of several forms of smart antenna technology. MIMO technology frequently offers significant increases, compared to single input/output technology, in data throughput and link range without additional bandwidth or transmit power. MIMO systems generally achieve this by higher spectral efficiency (e.g., more bits per second per hertz of bandwidth) and link reliability or diversity (e.g., reduced fading). In general, Close Loop (CL) multi-user (MU) MIMO systems require feedback of communications channel information from all the active users. The feedback overhead however, often decreases the efficiency of the MU-MIMO system capacity.

A frequent cellular network implementation may have multiple antennas at a base station (BS) and a single antenna on the mobile station (MS). In such an embodiment, the cost of the mobile radio may be minimized. As the costs for radio frequency (RF) components in mobile station are reduced, second antennas in mobile device may become more common. Multiple mobile device antennas may currently be used in Wi-Fi technology (e.g., IEEE 802.11n).

### SUMMARY

According to one general aspect, a method may include broadcasting, in a downlink direction to one or more mobile stations in a wireless network, a message that includes a channel quality threshold, and receiving a signal from at least one of the one or more mobile stations, the signal being received in an uplink direction on one or more resource blocks that have a channel quality, as measured by one of the one or more mobile station in a downlink direction, that is greater than or equal to the channel quality threshold.

According to another example embodiment, an apparatus may include a wireless transceiver, and a controller. The apparatus may be configured to: broadcast, in a downlink direction to one or more mobile stations in a wireless network, a message that includes a channel quality threshold, and receive a signal from at least one of the one or more mobile stations, the signal being received in an uplink direction on one or more resource blocks that have a channel quality, as measured by one of the one or more mobile station in a downlink direction, that is greater than or equal to the channel quality threshold.

According to another example embodiment, a method may include broadcasting, in a downlink direction to one or more mobile stations in a wireless network, a message that includes a channel quality threshold, transmitting, from a base station in a downlink direction, one or more signals on each of a plurality of resource blocks, and receiving a signal from at least one of the one or more mobile stations, the signal being received on a subset of resource blocks in an uplink direction that have a channel quality, as measured by one of the one or more mobile stations in the downlink direction, that is greater than or equal to the channel quality threshold.

According to another example embodiment, a method may include receiving a message at a mobile station from a base station in a wireless network, a message that includes a channel quality threshold, measuring a channel quality for each of a plurality of resource blocks in a downlink direction, selecting, based on the measuring, one or more resource blocks of the plurality of resource blocks that have a channel quality that is greater than or equal to the channel quality threshold, and transmitting a signal in an uplink direction to the base station on the selected one or more resource blocks.

According to another example embodiment, an apparatus may include a wireless transceiver, and a controller. The apparatus (e.g., the controller and the wireless transceiver) may be configured to receive a message at a mobile station from a base station in a wireless network, a message that includes a channel quality threshold, measure a channel quality for each of a plurality of resource blocks in a downlink direction. The controller may be configured to select, based on the measuring, one or more resource blocks of the plurality of resource blocks that have a channel quality that is greater than or equal to the channel quality threshold. And, the apparatus (e.g., controller and transceiver) may be configured to transmit a signal in an uplink direction to the base station on the selected one or more resource blocks.

According to an example embodiment, a method may include establishing an association between a base station and at least one mobile station (MS) via a communications channel, wherein the communications channel is divided into resource blocks, broadcasting a channel quality threshold message that includes a channel quality threshold, and receiving at least one channel quality reporting message, respectively from the at least one mobile station(s), each of the channel quality reporting messages including a sounding signal received via one or more of the resource blocks that have a measured channel quality that is greater than or equal to the channel quality threshold.

According to another example embodiment, a method may include establishing an association between the base station and at least one mobile station (MS) via a communications channel, wherein the communications channel is divided into resource blocks, broadcasting a channel quality threshold message that includes a channel quality threshold, receiving at least one reporting message, respectively from the at least one mobile station(s), indicating which resource blocks have a measured channel quality that is greater than or equal to the channel quality threshold, and allocating, in a time division multiplexing mode, resource blocks for communication with the mobile station(s) based, at least in part, upon the reporting message(s).

According to another example embodiment, a method may include establishing an association between the mobile station and a base station via a communications channel, wherein the communications channel is divided into resource blocks, receiving, from the base station, a broadcast channel quality threshold message including a channel quality threshold, measuring a channel quality for each of a plurality of the resource blocks, and if at least one resource block includes a channel quality that is greater than or equal to the channel quality threshold, transmitting a reporting message, to the base station, indicating which resource block(s) include a channel quality that is greater than or equal to the channel quality threshold.

The details of one or more implementations are set forth in the accompanying drawings and the description below. Other features will be apparent from the description and drawings, and from the claims.

A system and/or method for communicating information, substantially as shown in and/or described in connection with at least one of the figures, as set forth more completely in the claims.

### BRIEF DESCRIPTION OF THE DRAWINGS

FIG. 1 is a block diagram of an example embodiment of a system in accordance with the disclosed subject matter.

FIG. 2 is a block diagram of an example embodiment of an apparatus in accordance with the disclosed subject matter.

FIG. 3 is a block diagram of an example embodiment of a series of frames in accordance with the disclosed subject matter.

FIG. 4 is a block diagram of an example embodiment of a system in accordance with the disclosed subject matter.

FIG. 5 is a block diagram of an example embodiment of a system in accordance with the disclosed subject matter.

FIG. 6 is a table of an example embodiment of a coding scheme of system in accordance with the disclosed subject matter.

FIG. 7 is a flow chart of an example embodiment of a technique in accordance with the disclosed subject matter.

FIG. 8 is a flow chart of an example embodiment of a technique in accordance with the disclosed subject matter.

FIG. 9 is a flow chart of an example embodiment of a technique 1100 in accordance with the disclosed subject matter.

FIG. 10 is a flow chart of an example embodiment of a technique 1100 in accordance with the disclosed subject matter.

FIG. 11 is a flow chart of an example embodiment of a technique 1100 in accordance with the disclosed subject matter.

### DETAILED DESCRIPTION

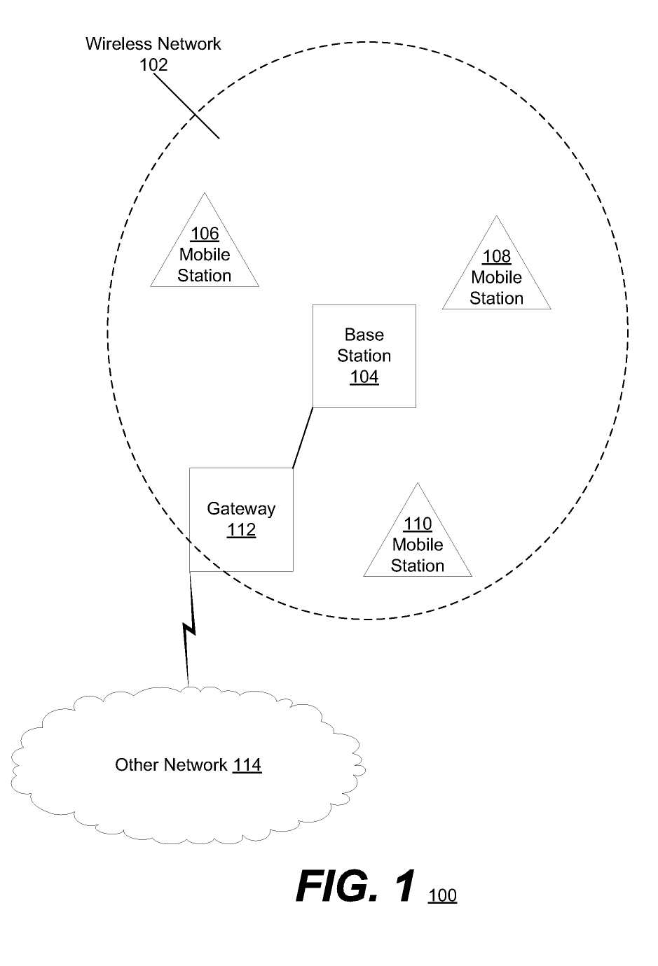

Referring to the Figures in which like numerals indicate like elements, FIG. 1 is a block diagram of a wireless network 102 including a base station (BS) 104 and mobile stations (MSs) 106, 108, 110, according to an example embodiment. Each of the MSs 106, 108, 110 may be associated with BS 104, and may transmit data in an uplink direction to BS 104, and may receive data in a downlink direction from BS 104, for example. Although only one BS 104 and three mobile stations (MSs 106, 108 and 110) are shown, any number of base stations and mobile stations may be provided in network 102. Also, although not shown, mobile stations 106, 108 and 110 may be coupled to base station 104 via relay stations or relay nodes, for example. The base station 104 may be connected via wired or wireless links to another network (not shown), such as a Local Area Network, a Wide Area Network (WAN), the Internet, etc. In various embodiments, the base station 104 may be coupled or connected with the other network 120 via an access network controller (ASN) or gateway (GW) 112 that may control, monitor, or limit access to the other network.

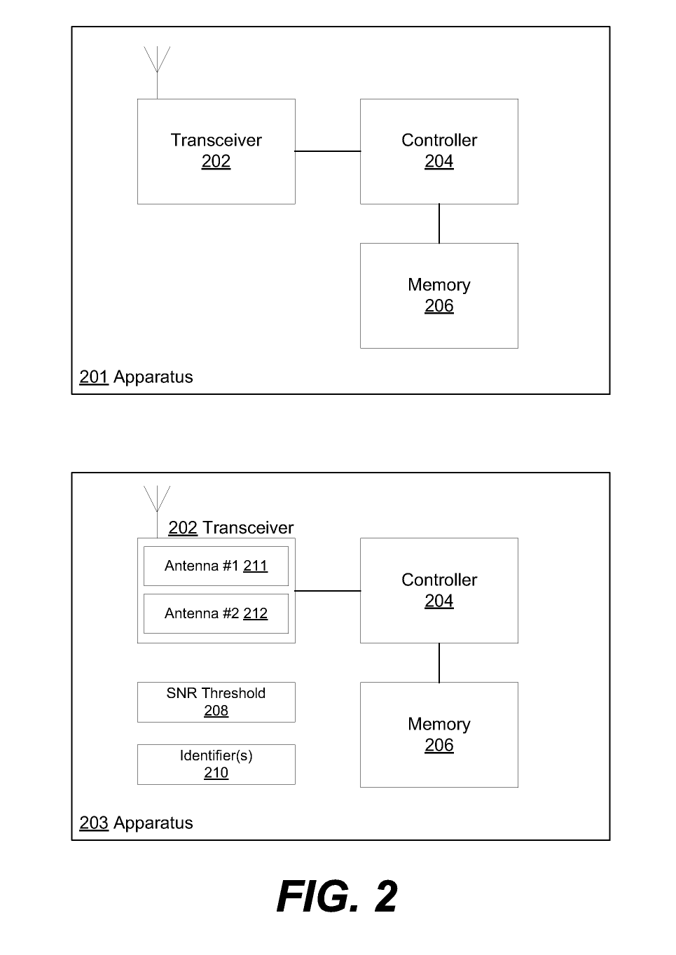

FIG. 2 is a block diagram of two example embodiments of apparatuses 201 and 203 in accordance with the disclosed subject matter. In one embodiment, the communications device 201 may include a base station (BS) or a mobile station (MS) such as that illustrated in FIG. 1. In one embodiment, the communications device 201 may include a transceiver 202, a controller 204, and a memory 206. In some embodiments, the transceiver 202 may include a wireless transceiver configured to operate based upon a wireless networking standard (e.g., WiMAX, WiFi, WLAN, etc.). In other embodiments, the transceiver 202 may include a wired transceiver configured to operate based upon a wired networking standard (e.g., Ethernet, etc.). In various embodiments, the controller 204 may include a processor. In various embodiments, the memory 206 may include permanent (e.g., compact disc, etc.), semi-permanent (e.g., a hard drive, etc.), and/or temporary (e.g., volatile random access memory, etc.) memory. For example, some operations illustrated and/or described herein, may be performed by a controller 204, under control of software, firmware, or a combination thereof. In another example, some components illustrated and/or described herein, may be stored in memory 206.

FIG. 2 is also a block diagram of a communications device 203 in accordance with an example embodiment of the disclosed subject matter. In one embodiment, the communications device 203 may include a base station (BS) or a mobile station (MS) such as that illustrated in FIG. 1. In one embodiment, the communications device 203 may include a wireless transceiver 202, a controller 204, and a memory 206. In some embodiments, the transceiver 202 may include a wireless transceiver configured to operate based upon a wireless networking standard (e.g., WiMAX, WiFi, WLAN, etc.). In other embodiments, the transceiver 202 may include a wired transceiver configured to operate based upon a wired networking standard (e.g., Ethernet, etc.). In various embodiments, the controller 204 may include a processor. In various embodiments, the transceiver 202 may include a plurality of antennas, such as antenna #1 211 and antenna #2 212. In one embodiment, the communications device 203 may include a channel quality threshold 208. In various embodiments, the channel quality threshold 208 may be stored by the memory 206. In some embodiments, the communications device 203 may include at least one identifier 210 configured to substantially uniquely identify each antenna (e.g., antennas 211 and 212). In various embodiments, the identifier 210 may be stored by the memory 206.

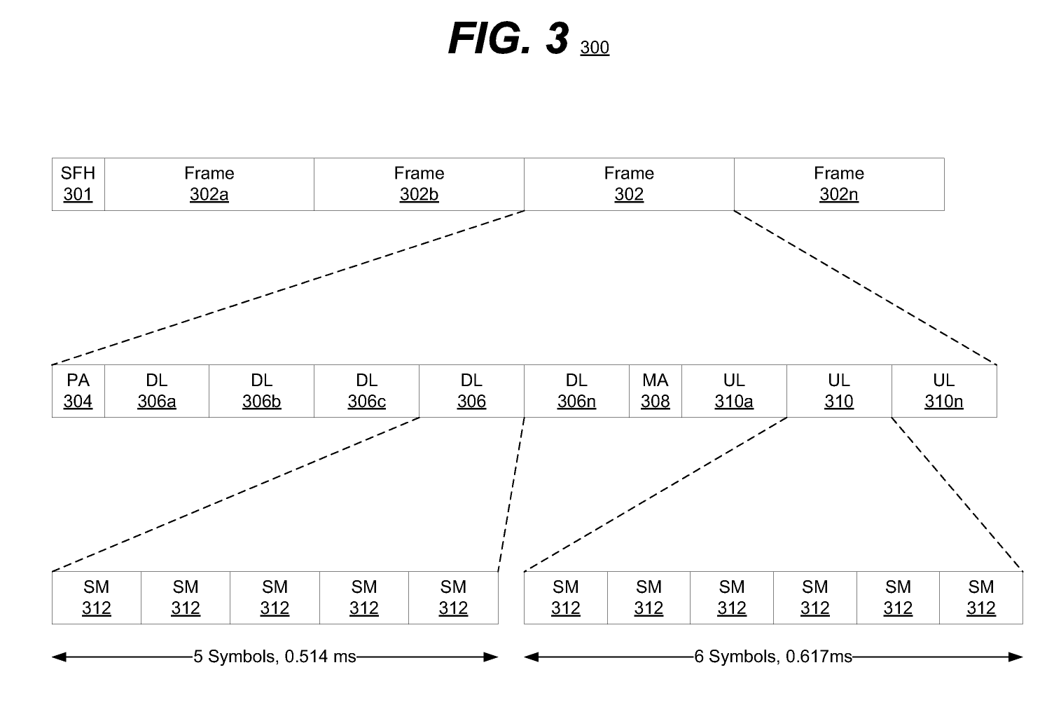

FIG. 3 is a block diagram of an example embodiment of a series of frames in accordance with the disclosed subject matter. In one embodiment, the base station and various mobile stations may communicate with each other using a series or plurality of frames or super-frame 300.

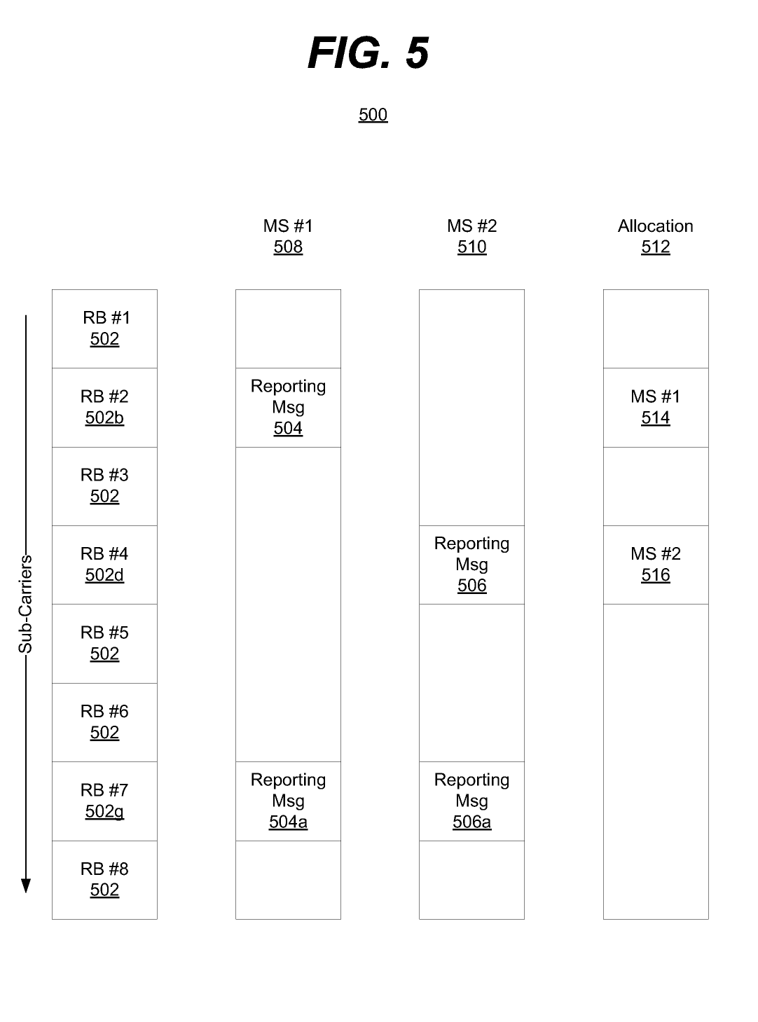

These frames may be transmitted over or via a communications channel. The following provides an overall context of the communications channel. In this context, a communications channel may include a medium used to convey information from a sender to a receiver. FIG. 3 illustrates the division of the communications channel as a function of time (e.g., time division multiplexing). In addition, a communications channel may also be divided as a function of frequency, illustrated more completely in FIG. 5. In various embodiments, this communications channel may include a plurality of frequencies or a bandwidth of frequencies. This bandwidth may be sub-divided into sub-channels or sub-carriers. Each of these sub-carriers may include their own respective bandwidth. In various embodiments, these sub-carriers may generally be of equal size.

In various embodiments, the communications channel may be divided by both time and frequency into resource blocks. In such an embodiment, a resource block may include a given sub-channel or sub-channels for a period of time. These resource blocks may provide the fundamental blocks of communication. In this context, a resource band may be the frequency and time based component of a resource block and include the sub-channels comprising a resource block. According to an example embodiment, a resource block may include a group of subcarriers, such as 18 subcarriers (as an example), or any number of subcarriers.

A controlling device (e.g., a base station), in one embodiment, may allocate resource blocks amongst mobile devices. In such an embodiment, the base station may attempt to perform this allocation in such a way as to reduce the number of un-received or un-usable (e.g., garbled, noise ridden, etc.) transmissions. In various embodiments, it may not be possible to make use of every possible resource block or resource band.

FIG. 3 illustrates a plurality of frames. In various embodiments, the plurality of frames may be organized into a super-frame 300. In one embodiment, this super-frame 300 may include a super-frame header 301 and frames 302a, 302b, 302, and 302n. Frame 302 may include a down-link (DL) portion and an uplink (UL) portion. In various embodiments, a DL sub-frame 306 may be reserved for communication from the base station to a mobile station. Conversely, an UL sub-frame 310 may be reserved for communication from the mobile station to the base station. Downlink (DL) may refer to a direction of transmission from base station to a mobile station, and uplink (UL) may refer to a direction of transmission from a mobile station to a base station.

In one embodiment, a frame 302 may include a pre-amble 304, a plurality of DL sub-frames (e.g., DL sub-frames 306a, 306b, 306c, 306, and 306n), a mid-amble 308, and a plurality of UL sub-frames (e.g., UL sub-frames 310a, 310, and 310n). In various embodiments, the mid-amble 308 and pre-amble 304 may, respectively, delineate the transition between the DL and UL portions of the frame 302 and between frames themselves. In one embodiment, the pre-amble 304 and mid-amble 308 may include a signal that is broadcast to any listening devices (e.g., mobile stations) within the range of the base station or other transmitting device.

Conversely, a DL sub-frame 306 or UL sub-frame 310 may include messages generally intended for a specific receiver or group of receivers. Occasionally these sub-frames may be used to broadcast information (e.g., resource allocation, channel condition feedback, etc.). These time based sub-frames may be, in one embodiment, additionally divided by frequency into the resource blocks (not shown) which are allocated to mobile stations to either receive or send information. In such an embodiment, the sub-frame may be the practical time division of the communications channel.

In various embodiments, the DL sub-frame 306 may include a plurality of symbols 312. In one specific embodiment, the DL sub-frame 306 may include five symbols 312 and duration of approximately 0.514 ms. In various embodiments, the UL sub-frame 310 may include a plurality of symbols 312. In one specific embodiment, the UL sub-frame 310 may include six symbols 312 and duration of approximately 0.617 ms. In various embodiments, these symbols 312 are orthogonal frequency-division multiple access (OFDMA) symbols. In one embodiment, an UL resource block may include a resource band or bandwidth of 18 sub-carriers, and a time duration or length of six symbols 312. In various embodiments, a resource block size may be configurable or predefined. It is understood that the above are merely a few illustrative examples to which the disclosed subject matter is not limited.

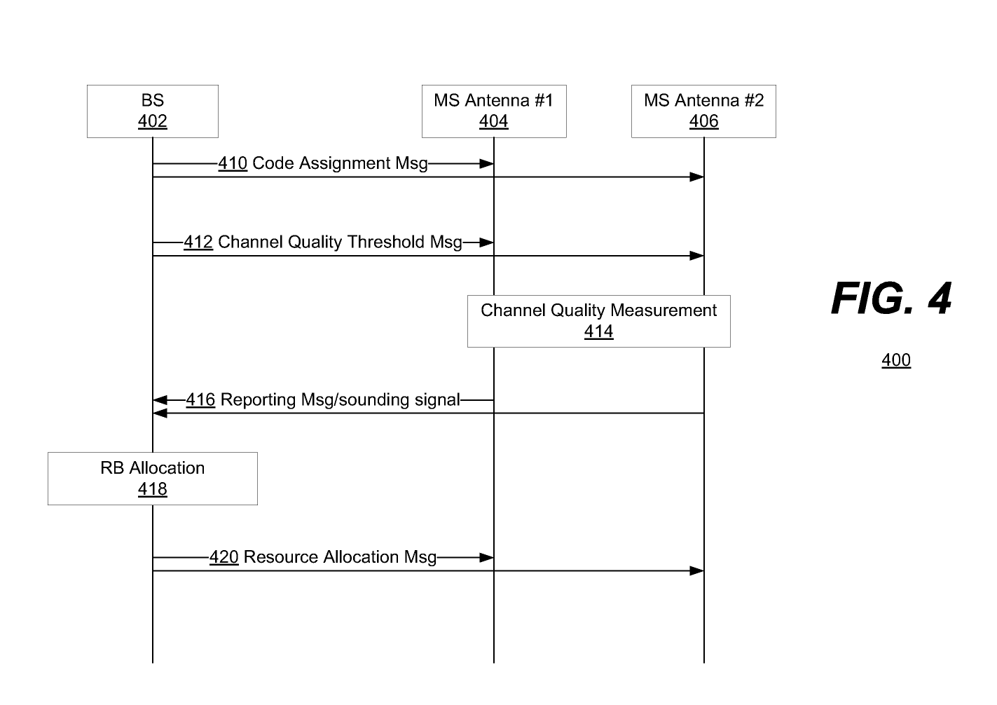

FIG. 4 is a block diagram of an example embodiment of a system 400 in accordance with the disclosed subject matter. In one embodiment, the system 400 may include a BS 402, and a mobile station. In various embodiments, the mobile station may include a first antenna 404 and a second antenna 406. However, it is understood that the disclosed subject matter is not limited to a fixed number of antennas and that FIG. 4 is merely an illustrative embodiment.

In one embodiment, the BS 402 may establish an association or a connection with at least one mobile station, as described above. In various embodiments, this establishment may include broadcasting a message identifying the BS 402, receiving a message from the MS requesting an association, and authenticating the MS; although, it is understood that the above is merely one illustrative example to which the disclosed subject matter is not limited.

In one embodiment, the BS 402 may broadcast or individually transmit a code assignment message 410 to a MS or each MS antenna 404 and 406. In various embodiments, this code assignment message 410 may include an assignment of a substantially unique identifier or code to the mobile station or to each antenna (e.g., MS antennas 404 and 406). In such an embodiment, this code may be used to identify from which antenna a message (e.g., reporting message 416) originates, as described below. Alternatively, the unique code or identifier may be assigned to a mobile station, e.g., a different identifier to each mobile station in the network which may allow the BS to identify from which mobile station a transmitted signal originates. In various embodiments, a resource block may not be large enough to allow for uniquely identifying all associated antennas. In such an embodiment, the BS 402 may re-assign mostly unique identifiers to each antenna (including any new antennas) or, in one embodiment, the BS 402 may simply accept that the origin of some messages (e.g., reporting message 416) may be indeterminate and assign identifiers in such a way as to minimize or manage that possibility.

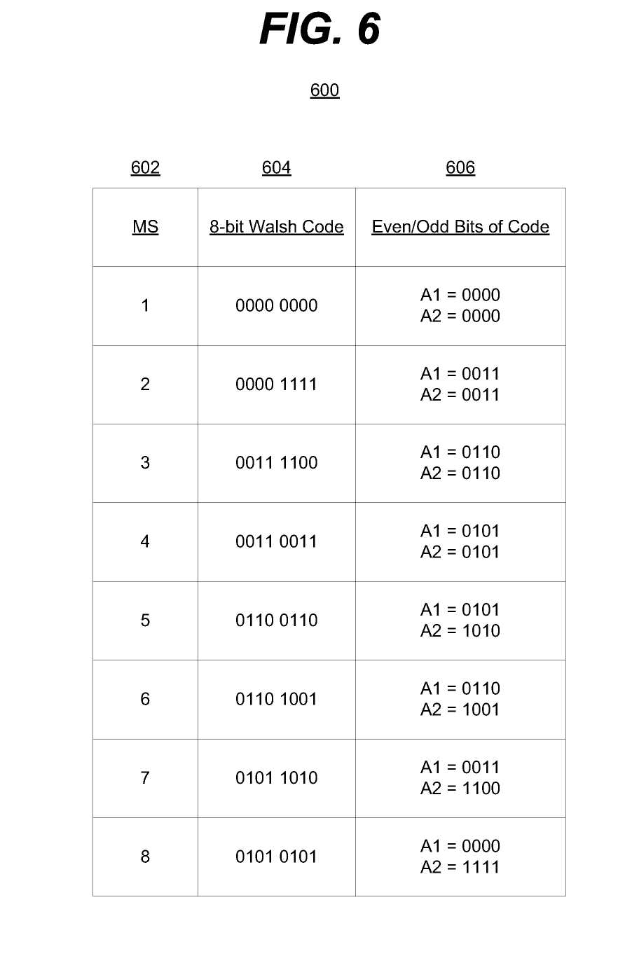

In various embodiments, the code assignment message 410 may include a specific message. In another embodiment, the code assignment message 410 may be included as part of another message (e.g., a MS attachment response message, etc.). In such an embodiment, the code assignment message 410 may include a parameter or element of the other or carrier message. In one such embodiment, the code assignment message 410 may be or include a type-length-value (TLV) element that specifics that it is a parameter or element including the code assignment and a value for the code or codes assignment. A specific embodiment of a substantially uniquely identifiable code assignment is discussed below in reference to FIG. 6. Although, it is understood that the above are merely a few illustrative examples to which the disclosed subject matter is not limited.

In one embodiment, the BS 402 may transmit a message, which may be referred to as a channel quality threshold message 412, to at least one mobile station actively associated with the base station. The channel quality threshold message 412 may include (or may identify) a channel quality threshold. A variety of different types of channel quality may be used or may be identified, such as signal-to-noise ratio, a signal-to-interference and noise ratio, received signal strength, or any other channel quality. In various embodiments, a MS may temporarily go inactive or otherwise leave the network including the BS. In various embodiments, these MSs may not receive the channel quality threshold message 412. In various embodiments, the BS 402 may broadcast this channel quality threshold message 412, as described above in reference to the code assignment message 410.

As an example channel quality, a SNR may be defined, for example, as the ratio of an average signal power to the noise power corrupting the signal. In various embodiments, a signal-to-noise ratio compares the strength of a desired signal (e.g., data communication) to the strength of background noise. In general, the higher the ratio, the less obtrusive the background noise is and, therefore, the more likely it is that information (i.e., the signal) may be transmitted without errors.

In one embodiment, the BS 402 may determine a channel quality threshold below which the BS 402 has determined that communication is not worthwhile or desirable, for example. In various embodiments, this channel quality threshold level may be predetermined. In another embodiment, this channel quality threshold level may be configurable (e.g., via a network administration server, during BS 402 provisioning configuration, etc.). In yet another embodiment, this channel quality threshold (e.g., SNR threshold) may be dynamically adjustable. In one embodiment, the BS 402 may not receive an acceptable response from the MSs, as described below. In such an embodiment, the BS 402 may lower the channel quality (e.g., SNR) threshold until a minimum value is reached or the BS 402 is satisfied with the MSs' responses. In various embodiments, the definition of what level of response the BS 402 considers acceptable may be predefined, configurable, dynamically adjustable or a combination thereof. In various embodiments, this level of acceptability may be in terms of quantity of response or in terms of final allocation options, as described below.

Block 414 illustrates that, in one embodiment, upon receipt of the broadcast channel quality threshold message 412, the MSs or their antennas (e.g., MS antennas 404 and 406) may measure the channel quality of some or all of the sub-carriers or resource bands of the communications channel. In various embodiments, measuring the channel quality of some or all of the sub-carriers may include measuring the channel quality (e.g., SNR) of the resource block or resource band used to transmit the broadcast channel quality threshold message 412. In some embodiments, the SNR may be measured for each antenna (e.g., MS antennas 404 and 406). In another embodiment, the channel quality may be measured at one antenna or an average of all antennas may be computed for the MS.

In an example embodiment, a MS may measure a channel quality by measuring a channel quality of each of a plurality of resource blocks in a downlink direction, e.g., by the MS measuring an average channel quality for each resource block. For example, a resource block may be a group of subcarriers, and the mobile station may measure a channel quality for a resource block by measuring the average channel quality for each resource block. For example, the MS may measure an average channel quality for a resource block by determining an average channel quality across a group of subcarriers, where the resource block may include the group of subcarriers. Other techniques may be used to measure a channel quality for a resource block.

In various embodiments, the MS or each antenna of the MS (e.g., MS antennas 404 and 406) may respond to the channel quality threshold message 412 with a reporting message 416. In one embodiment, the reporting message 416 may consume or occur not just during a specifically allocated resource block, but on an entire UL OFDMA symbol. In one such embodiment, not just one MS, but all MSs associated with the BS 402, or all the antennas of the MSs associated with the BS 402 may substantially simultaneously transmit their respective reporting messages 416. This is contrasted with what, in one embodiment, is “normal” communication in which a MS (or its antennas) is allocated specific resource blocks and communication only occurs on those resource blocks to avoid interference from other MSs.

In one embodiment, to minimize such interference, a MS or the MSs individual antennas may only transmit their reporting message 416 using one or more resource blocks (e.g., subcarriers or group(s) of subcarriers) whose channel quality was equal to or above (or greater than or equal to) the channel quality threshold as established or identified by the BS 402 in the channel quality threshold message 412. This is described below and illustrated in FIG. 5. It is contemplated that various MSs, as mobile devices, may be at different locations and therefore experience different channel qualities among different resource blocks. In one embodiment, if the reporting message 416 is transmitted only using the sub-carriers or resource bands experiencing a channel quality equal to or above the SNR threshold, the probability of inter-MS interference within any one resource block or resource band may be reduced.

In an example embodiment, each mobile station may receive one or more signals on each of a plurality of resource blocks in a downlink direction, where the one or more signals may include one or more of a preamble, a midamble and/or a pilot subcarrier signal transmitted by the base station. Each mobile station may measure the channel quality of the received downlink signal(s) for each of one or more resource blocks. For example, each mobile station may measure a channel quality of a received signal(s) for each group of subcarriers. Each mobile station may then compare the channel quality of each measured resource block to the channel quality threshold, and may, for example, select one or more resource blocks having a channel quality that is greater than or equal to the channel quality threshold identified by message 412.

In an example embodiment, each MS may then transmit, in an uplink direction to the BS, a reporting message 416 which may identify the selected one or more resource blocks that have a measured downlink channel quality that is greater than or equal to the channel quality threshold.

In an example embodiment, the transmitting a reporting message 416 may include a MS transmitting a sounding signal in an uplink direction on one or more resource blocks that have a channel quality, as measured by the mobile station in a downlink direction, that is greater than or equal to the channel quality threshold. Thus, for example, the sounding signal may be transmitted in an uplink direction on resource blocks that have a measured channel quality in a downlink direction that was greater than or equal to a threshold, for example. In an example embodiment, the sounding signal may be a signal that identifies one or more resource blocks by providing the sounding signal on such identified resource blocks. Thus, the sounding signal may, for example, provide a preselected pattern, e.g., all ones (is), or other signal pattern, on each resource block, e.g., where the presence of the sounding signal may identify the selected group of resource blocks. In this example embodiment, the sounding signal may identify resource blocks that have a downlink measured channel quality that exceeds a threshold, e.g., the sounding signal may be transmitted on (e.g., only on) those resource blocks having a measured channel quality that is greater than or equal to the channel quality threshold, for example. Thus, in this manner, each MS may (implicitly) identify one or more resource blocks by transmitting a sounding signal on each of the identified resource blocks. In an example embodiment, it may be more efficient to transmit a simple sounding signal on each resource block (or subcarrier or group of subcarriers) having a downlink channel quality that exceeds a threshold, rather than transmitting, e.g., a packet or frame that includes a bit or flag that identifies each selected resource block that has a channel quality that is greater than or equal to the channel quality threshold.

Also, in another example embodiment, the measurement of channel quality of each resource block and sending a reporting message 416, may be performed for each antenna of the (or each) mobile station.

In one embodiment, the MS or the MS antennas (e.g., MS antennas 404 and 406) may only transmit a maximum number of reporting messages 416 or, said another way, transmit the reporting message 416 via a maximum number of resource blocks or resource bands. In some embodiments, only the resource blocks or resource bands with the highest channel quality (e.g., SNR) may be used to satisfy this maximum limit. In various embodiments, the maximum number of resource blocks or resource bands used may be predefined (e.g., via a networking standard used by the system 400). In another embodiment, the maximum number of resource blocks or resource bands used or reported may be dynamically set by the BS 402. In one embodiment, this may occur via messages such as, the code assignment message 410, the channel quality threshold message 412, etc. Also, in one embodiment, the maximum number of reporting resource blocks or resource bands may be set similarly to that which is described above in reference to other messages. In various embodiments, the BS 402 may alter this number as a function of communication channel conditions, number of MSs associated with the BS 402, etc.; although, it is understood that the above are merely a few illustrative examples to which the disclosed subject matter is not limited.

In a different embodiment, the BS 402 may request that a number (e.g., five) of reporting messages 416 be sent regardless of the channel quality threshold. In such an embodiment, the SNR of each resource block or resource bands may be measured and the resource blocks or resource bands with the highest channel quality or highest SNR may be used for the reporting message 416. In such an embodiment, the channel quality threshold may be considered zero, with a set limit or maximum number of reporting messages 416 returned. Or, in other words, the BS may request that a number (e.g., five) of resource blocks be used to transmit the reporting message 416 (or to transmit the sounding signal). Thus, in such case, each MS may transmit a reporting message, which may include for example, a sounding signal(s) provided on each of the five resource blocks (e.g., five groups of subcarriers) having the highest (or best) channel quality as measured in the downlink direction by the mobile station, according to an example embodiment.

In various embodiments, the reporting message 416 may include only the assigned code or identifier from the code assignment message 410. In such an embodiment, only two pieces of information may be conveyed by the reporting message 416: which resource block(s) or resource band(s) are above the channel quality threshold and which MS (or MS antenna) is transmitting the reporting message (or which MS or antenna considers the resource block or resource band above the channel quality threshold). In various embodiments, other message formats may be used to convey additional or different information. In an example embodiment, each MS (or antenna) may be assigned a unique code, such as a different orthogonal Code Division Multiple Access (CDMA) code via code assignment message 410. Each MS (or each antenna in a multiple antenna embodiment) may encode a corresponding sounding signal using the orthogonal CDMA code assigned to the MS, for example, to generate an encoded sounding signal on the selected resource blocks having a channel quality that is greater than or equal to the threshold. Thus, the presence of the sounding signal on one or more resource blocks may identify resource blocks having a channel quality that exceeds the threshold, and the encoding of the sounding signal using the orthogonal code may be used to identify the transmitting MS or transmitting antenna.

In such an embodiment, the BS 402 may receive a plurality of reporting messages 416 via a plurality of resource blocks. In various embodiments, the BS 402 may determine which resource blocks or resource bands experience a sufficient (e.g., as defined by the channel quality threshold) channel quality and are therefore considered “good”, and from which MS or MS antenna (e.g., MS antennas 404 and 406) the reporting message 416 delivered via each “good” resource block originated. In various embodiments, these “good” resource blocks or resource bands may be considered allocate-able to the MSs who transmitted the reporting messages 416 via them.

In some embodiments, multiple MSs may transmit a reporting message 416 via the same resource block or resource band. In such an embodiment, the BS 402 may be able to determine that a resource block or resource band is “good”, but not which MS transmitted the reporting message 416 (e.g., due to inter-symbol interference, non-unique code assignments, etc.). In various embodiments, the BS 402 may mark the resource block or resource band as “bad” or “not good” and attempt to not use the resource block for allocation purposes.

In various embodiments, the broadcasting of the channel quality threshold message 412 may occur as part of a broadcast message directly before the UL sub-frames of a frame (e.g., a mid-amble). In such an embodiment, the first UL sub-frame may be used or reserved for the transmission of the expected reporting messages 416. In such an embodiment, the latency between the channel quality threshold message 412 and the reporting messages 416 may be reduced. Although, it is understood that the above is merely one illustrative example to which the disclosed subject matter is not limited.

Block 418 illustrates that, in one embodiment, the BS 402 may perform resource block (RB) allocation based in part upon the received reporting message 416. In various embodiments, this RB allocation 418 may include RB allocation for MSs during both a DL sub-frame portion and/or an UL sub-frame portion. In various embodiments, a RB allocation message 420 may occur during the normal resource block allocation of the next or subsequent frame. For example, a BS may allocate one or more resource blocks to a MS in either an UL or DL direction, based on the reporting message 416 received from the MS. For example, the BS may allocate one or more resource blocks to a MS corresponding to the resource blocks used to transmit the reporting message 416 (e.g., corresponding to the resource blocks that the sounding signal was transmitted on). For example, due to symmetry in uplink and downlink channels, a subcarrier or group of subcarriers having a good channel quality as measured by a MS in a downlink direction may also typically have a good channel quality in the uplink direction, for example. Thus, resource blocks identified by the reporting message 416 or sounding signal may be assigned to a reporting MS for either UL transmission from the MS or DL transmission to the MS, as an example.

In various embodiments, the BS 402 may transmit a channel quality threshold message 412 opportunistically. In another embodiment, the BS 402 may transmit a channel quality threshold message 412 periodically or, in one embodiment, as part of every frame. In various embodiments in which the channel quality threshold message 412 is transmitted opportunistically, the BS 402 may monitor or accumulate data regarding the communications channel conditions (e.g., number of resend requests, number of MSs, channel quality experienced by the BS 402, etc.). In such an embodiment, the BS 402 may broadcast a channel quality threshold message 412 when it is determined that the communications channel condition has fallen below an acceptable standard or threshold. In various embodiments, this standard or threshold may be predetermined, configurable, or dynamically adjustable, etc. In various embodiments, this standard or threshold may be a relative (versus absolute) standard (e.g., a rate of change of the communications channel's condition, etc.).

In various embodiments, the opportunistic unsolicited transmission of the channel quality threshold message 412 may reduce the overall overhead of MIMO feedback (e.g., as compared to non-opportunistic schemes). In some embodiments, the periodic or opportunistic unsolicited transmission of the channel quality threshold message 412 may reduce the power requirements or drain experienced by the MSs (e.g., due to the reduced transmission of the reporting message 416). In yet another embodiment, reallocation of resource blocks based upon the reported channel quality may reduce the need for MSs with lower channel quality to transmit information using higher power levels, due to specifically selected RBs (resource blocks) versus randomly or non-channel quality aware selected RB allocation).

FIG. 5 is a block diagram of an example embodiment of a system 500 in accordance with the disclosed subject matter. As opposed to FIG. 3 which is oriented by time, FIG. 5 is oriented by frequency and shows a plurality of resource blocks (RBs) or resource bands 502 as a function of sub-carriers. In this context, a resource band may be a resource block without a defined time component. Colloquially, the term “resource block” may be used when referring to a “resource band”. FIG. 5 illustrates one embodiment of reporting messages received by a base station and a possible resource block allocation determined using the reporting messages. In one embodiment, the system 500 may include a base station (not shown) and two MSs 508 and 510. It is understood that the above are merely one illustrative example to which the disclosed subject matter is not limited, and that in various embodiments the number of resource blocks, MSs, reporting messages, etc. may be higher, in some cases much higher. Also, for purposes of simplicity it is assumed that, in this embodiment, the MSs 508 and 510 may only have a single antenna each, or that all of their antennas experience substantially the same channel quality for each resource block.

In one embodiment, first MS 508 may transmit two reporting messages 504 and 504a. In one embodiment, the reporting message 504 may make use of or be transmitted via resource block #2 502b. Likewise, the reporting message 504a may make use of or be transmitted via resource block #7 502g. The reporting message(s) transmitted via the resource blocks may be a sounding signal(s), as described above.

In one embodiment, second MS 510 may transmit two reporting messages 506 and 506a. In one embodiment, the reporting message 506 may make use of or be transmitted via resource block #4 502d. Likewise, the reporting message 506a may make use of or be transmitted via resource block #7 502g. Although multiple reporting messages are described, with one reporting message on each resource block, these multiple messages may be considered, for example, as one reporting message transmitted on multiple resource blocks. Or, in other words, this may include either one sounding signal transmitted on multiple resource blocks, or a sounding signal transmitted on each resource block. Either way, whether it is one message or one sounding signal across multiple resource blocks, or a different reporting message or sounding signal on each resource block, these may be considered to be substantially the same, according to an example embodiment.

In various embodiments, the BS may allocate two resource blocks or two per time period (as time in excess of one RB is not represented in FIG. 5) to the MSs 508 and 510. MS 508 may be allocated resource block #2 50b as its reporting message 504 was transmitted via this resource block. The second MS 510 may be allocated resource block #4 50d as its reporting message 506 was transmitted via this resource block. In such an embodiment, the BS may allocate resource blocks based, in part, upon the quality of channel quality experienced and reported by the various MSs.

In another embodiment, the BS may also consider the amount of data to be transmitted between the respective MSs and the BS. In such an embodiment, if there is less need for resource blocks than there are “good” resource blocks, only the number of resource blocks needed may be allocated. Conversely, in one embodiment, if the amount of data to be transmitted (either in DL or UL sub-frames) is greater than number of “good” resource blocks, the BS may only allocate the “good” RBs and postpone data transmission. In another embodiment, faced with the same transmission needs and insufficient “good” resource blocks, may allocate non-“good” resource blocks and effectively take a chance that the data will be correctly received. It is understood that the above are merely a few illustrative example of allocation choices and trade-offs to which the disclosed subject matter is not limited.

In some embodiments, the BS may have difficulty determining which of the two MSs 508 or 510 transmitted the reporting message occurring on or via resource block #7 502g. In such an embodiment, the BS may refrain from allocating resource block #7 502g. In another embodiment, if the transmitting MSs of the co-existing or correlated reporting messages 504a and 506a may be determined, the BS may time multiplex the allocation of the resource block #7 502g. In yet another embodiment, even if the transmitting MSs of the co-existing or correlated reporting messages 504a and 506a may be determined, the BS may refrain from allocating the resource block #7 502g. It is understood that the above are merely a few illustrative example of allocation choices and trade-offs to which the disclosed subject matter is not limited.

FIG. 6 is a table 600 of an example embodiment of a coding scheme of system in accordance with the disclosed subject matter. As described above, a message may be transmitted to and received by each MS or MS antenna that assigns a substantially unique or orthogonal code to each antenna or MS. Table 600 illustrates an example embodiment of a coding scheme that may be used to substantially uniquely identify a plurality (e.g., eight) MSs. In the illustrated example, each MS may include a maximum of two antennas. In various embodiments, the number of MSs, number of antennas, and coding scheme may differ. For example, in one embodiment, a coding scheme may be used that includes substantially unique codes for up to 16 MSs, having a maximum of two antennas each. It is understood that the above are merely a few illustrative examples to which the disclosed subject matter is not limited.

In one embodiment, the table 600 may include a MS column 602 illustrating which MS, of the maximum eight, is assigned the code. It is understood that the codes need not be assigned sequentially or in order. The table 600 may also include the column 604 illustrating the 8-but Walsh code assigned to each MS. It is noted that each MS is assigned a different and uniquely identifiable 8-bit Walsh code. Table 600 may include column 606 that identifies the 4-bit Walsh code assigned to each antennas of the corresponding MS.

In one embodiment, the coding scheme may include a CDMA code, such as a Walsh code. In this context a Walsh code may be used to uniquely define individual antennas or MSs. In various embodiments, Walsh codes may be mathematically orthogonal codes. As such, if two Walsh codes are correlated, the result may be intelligible only if these two codes are the same. As a result, a Walsh-encoded signal may appear, in one embodiment, as random noise to a CDMA capable device, unless that terminal uses the same code as the one used to encode the incoming signal. In various embodiments, such a device may include the base station that assigned the Walsh code.

As described above, in one embodiment, after a BS receives all the MS's reporting messages, the BS may check which MS is reporting its 8-bits of Walsh-code in the different resource blocks. Secondly, in one embodiment, the BS may use the even bits of the 8-bit Wash-code to determine if the MS antenna #1 transmitted a reporting message. In such an embodiment, BS may also use the odd bits of the 8-bit Wash-code to determine if MS antenna #2 transmitted a reporting message. Frequently, all of the antennas of a MS will experience substantially the same SNR. However, occasionally this may not be the case (e.g., a SNR barely equal to the threshold, a broken antenna, etc.).

In one embodiment, because the BS uses the 4-bits of the 8-bit Walsh-code to estimate the channel condition of MS antennas #1 and #2, only 4 pair of even and odd Walsh-codes may be orthogonal to one another. In such an embodiment, it can only be guaranteed that 4 sets of unique codes without channel collision may exist for the MSs with two transmit antennas.

For example, in various embodiments, if first the BS collects the 4 even bits of Wash-codes (i.e., bits #0, 2, 4, and 6) from all the 8-bit Walsh-codes, and the BS collects the 4 odd bits of the Wash-codes (i.e., bits #1, 3, 5, and 7), only the first 4 sets of Walsh-codes may be orthogonal and the second 4 sets of Walsh-codes may be correlated or repeats in some way with the first 4 sets of Walsh-codes. In various embodiments, the Walsh code for each antenna may be interleaved to form a Walsh code for the MS.

Therefore, if one MS transmits its Walsh-code which belongs to the first 4 sets of Walsh-codes and another MS transmits the Walsh-code which belongs to the second 4 sets of Walsh-codes, then these two MSs may not have identifiably unique antenna codes in the same resource band or block at the same time. Therefore, in one embodiment, a code collision or repetition may have a greater than zero probability of occurring. In various embodiments, if two repetitious or correlated Walsh-codes have a collision, then no channel information may be extracted from them.

In various embodiments, the BS may select a channel quality threshold value or maximum number of reporting messages, such that, if the active MSs are not close to the maximum capacity of users (e.g., 8 MSs), the probability of a code collision probability may be very low. Conversely, in some embodiments, if multiple MSs have the same correlated resource block (e.g., resource block #7 502g of FIG. 5) and their 4 antenna bits (e.g., even or odd bits) of their respective Walsh-codes are not orthogonal to each other, a BS may transmit an unsolicited code assignment message to assign a new Walsh-code to the user in order to reduce the probability of code collision.

In various embodiments, a resource block may include the capability of transmitting more bits than are necessary or used for the coding scheme (e.g., Walsh code). In such an embodiment, the extra bits may be used for purpose other than identifying the transmitting MS or MS antenna. For example, a resource block may include 18 sub-carriers or bits of information. Such a resource block may, in one embodiment, be used to transmit a 16-bit Walsh code, leaving 2 bits unused. In various embodiments, these unused bits may be positioned at the ends of the resource block to provide a buffer region for noise and inter-resource block interference. In another embodiment, the two bits may be assigned a special purpose or convey information not previously discussed. In yet another embodiment, the bits may be used to identify the antennas of the MS and an even/odd scheme as described above may not be used. Although, it is understood that the above are merely a few illustrative examples to which the disclosed subject matter is not limited.

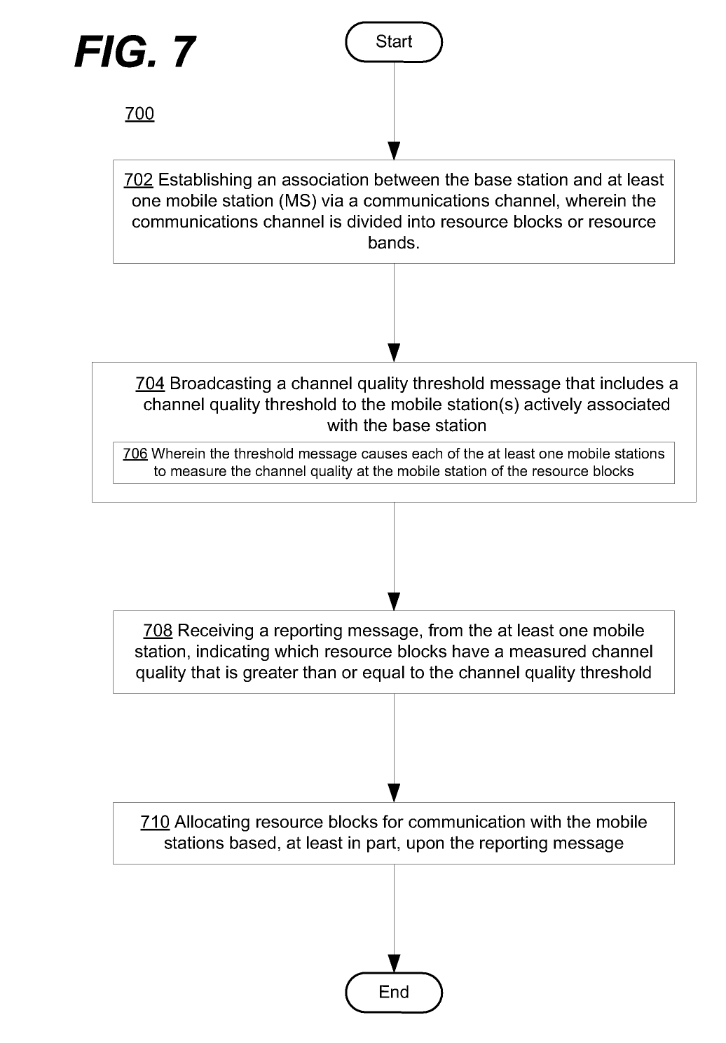

FIG. 7 is a flow chart of an example embodiment of a technique 700 in accordance with the disclosed subject matter. In various embodiments, the technique 700 may be used or generated by an apparatus or system as shown and illustrated by FIG. 1, 2, or 4, as described above.

Block 702 illustrates that, in one embodiment, an association between the base station and at least one mobile station (MS) may be established via a communications channel, wherein the communications channel is divided into resource blocks or resource bands, as described above. In various embodiments, establishing may include assigning a substantially uniquely identifiable code (e.g., a Walsh code) to each antenna of the mobile stations, as described above. In one embodiment, this action may occur separately, as described above. In various embodiments, the action(s) described above may be performed by a base station (e.g., base station 104 of FIG. 1) or a transceiver (e.g., transceiver 202 of FIG. 2), as described above.

Block 704 illustrates that, in one embodiment, a channel quality threshold message may be broadcast that includes a channel quality threshold to the mobile station(s) actively associated with the base station, as described above. In one embodiment, broadcasting may include broadcasting a mid-amble message that includes a channel quality threshold value, as described above. In one embodiment, broadcasting may include accumulating data on the condition of the communications channel; and, when the condition of the communications channel falls below a predetermined threshold, broadcasting the channel quality threshold message, as described above. In various embodiments, the action(s) described above may be performed by a base station (e.g., base station 104 of FIG. 1), a transceiver (e.g., transceiver 202 of FIG. 2), or a controller (controller 204 of FIG. 2) as described above.

Block 706 illustrates that, in various embodiments, the threshold message may cause each of the at least one mobile stations to measure the channel quality at the mobile station of the resource blocks, as described above. In some embodiments, wherein a mobile station includes a plurality of antennas, the threshold message may cause the mobile station to measure the channel quality of the resource blocks for each antenna of the mobile station, as described above. In various embodiments, the action(s) described above may be performed by a mobile station (e.g., mobile station 106 of FIG. 1), a transceiver (e.g., transceiver 202 of FIG. 2), or a controller (controller 204 of FIG. 2) as described above.

Block 708 illustrates that, in one embodiment, a reporting message may be received, from the at least one mobile station, indicating which resource blocks have a measured channel quality that is greater than or equal to the channel quality threshold, as described above. In one embodiment, receiving may include receiving a message encoded such that each of the at least one mobile stations is substantially identifiably unique, as described above. In one embodiment, receiving may include receiving the reporting message from a mobile station only if the mobile station includes at least one resource block with a channel quality equal to or above the channel quality threshold value, as described above. In one embodiment, receiving may include receiving a reporting message that includes an interleaved Walsh code, as described above. In one embodiment, receiving may include receiving a reporting message, via the resource blocks measured to have a channel quality equal to or above the channel quality threshold by the measuring mobile station that identifies the measuring mobile station, as described above. In various embodiments, the action(s) described above may be performed by a base station (e.g., base station 104 of FIG. 1) or a transceiver (e.g., transceiver 202 of FIG. 2), as described above.

Block 710 illustrates that, in one embodiment, allocating resource blocks for communication with the mobile stations based, at least in part, upon the reporting message, as described above. In one embodiment, allocating or receiving a reporting message may include determining from which mobile station each reporting message was transmitted, as described above. In one embodiment, allocating or receiving a reporting message may include, if the transmitting mobile station cannot be determined, treating the resource blocks indicated in the reporting message as being below the channel quality threshold, as described above. In various embodiments, the action(s) described above may be performed by a base station (e.g., base station 104 of FIG. 1), a transceiver (e.g., transceiver 202 of FIG. 2), or a controller (controller 204 of FIG. 2) as described above.

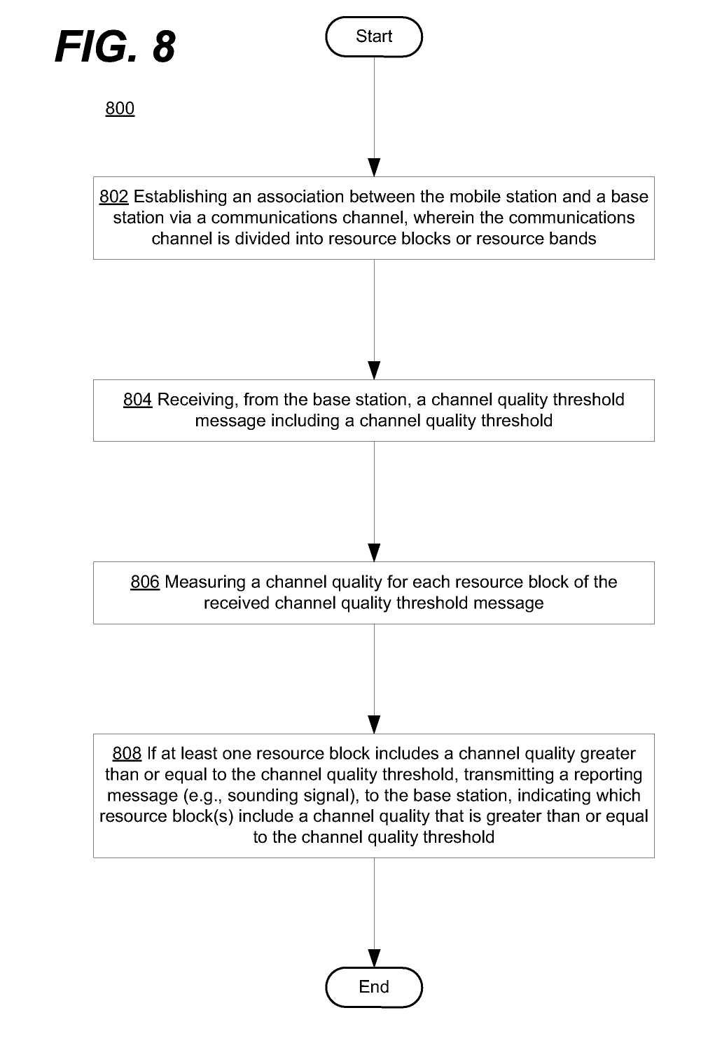

FIG. 8 is a flow chart of an example embodiment of a technique 800 in accordance with the disclosed subject matter. In various embodiments, the technique 800 may be used or generated by an apparatus or system as shown and illustrated by FIG. 1, 2, or 4, as described above.

Block 802 illustrates that, in one embodiment, an association between the mobile station and a base station may be established via a communications channel, wherein the communications channel is divided into resource blocks or resource bands, as described above. In various embodiments, establishing may include being assigned a substantially unique or orthogonal identifier code, as described above. In other embodiments, this code may be assigned outside of the establishment procedure, as described above. In various embodiments, the action(s) described above may be performed by a mobile station (e.g., mobile station 106 of FIG. 1), a transceiver (e.g., transceiver 202 of FIG. 2), or a controller (controller 204 of FIG. 2) as described above.

Block 804 illustrates that, in one embodiment, a channel quality threshold message may be received, from the base station, wherein the message includes a channel quality threshold value, as described above. In various embodiments, the action(s) described above may be performed by a mobile station (e.g., mobile station 106 of FIG. 1), or a transceiver (e.g., transceiver 202 of FIG. 2) as described above.

Block 806 illustrates that, in one embodiment, a channel quality for each resource block or resource band of the received channel quality threshold message may be measured, as described above. In various embodiments, measuring may include measuring a channel quality for each resource block or resource band for each antenna, as described above. In various embodiments, the action(s) described above may be performed by a mobile station (e.g., mobile station 106 of FIG. 1), a transceiver (e.g., transceiver 202 of FIG. 2), or a controller (controller 204 of FIG. 2) as described above.

Block 808 illustrates that, in one embodiment, if at least one resource block includes a channel quality equal to or above the channel quality threshold value, a reporting message may be transmitted, to the base station, indicating which resource block(s) include a channel quality that is greater than or equal to the channel quality threshold, as described above. In one embodiment, transmitting may include interleaving the substantially unique identifier code for each antenna to form the reporting message, as described above. In various embodiments, transmitting may include transmitting the reporting message via only the resource blocks or resource bands that include a channel quality equal to or above the channel quality threshold value, as described above. In various embodiments, the action(s) described above may be performed by a mobile station (e.g., mobile station 106 of FIG. 1), or a transceiver (e.g., transceiver 202 of FIG. 2) as described above.

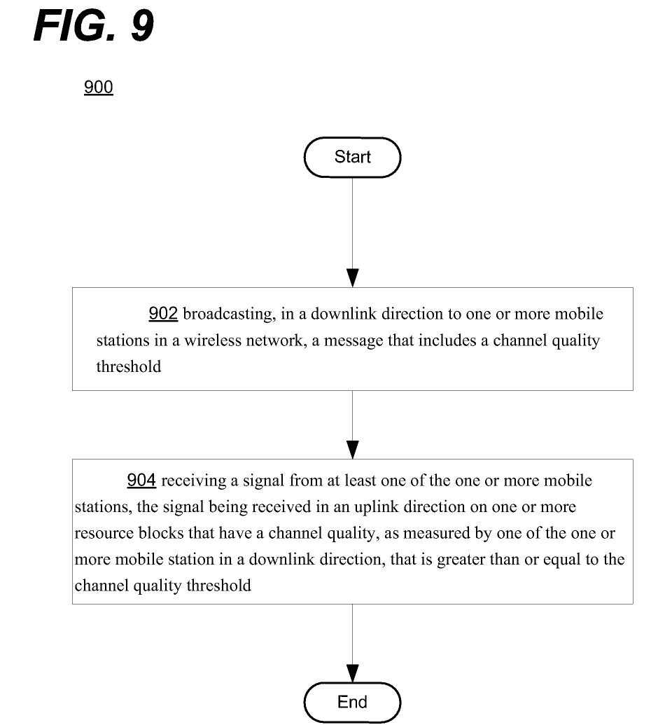

FIG. 9 is a flow chart of an example embodiment of a technique 900 in accordance with the disclosed subject matter.

Block 902 may include broadcasting (e.g. a base station broadcasting), in a downlink direction to one or more mobile stations in a wireless network, a message that includes a channel quality threshold. Block 904 may include receiving a signal from at least one of the one or more mobile stations, the signal being received in an uplink direction on one or more resource blocks that have a channel quality, as measured by one of the one or more mobile station in a downlink direction, that is greater than or equal to the channel quality threshold.

In an example embodiment, in the technique 900, the signal may include a sounding signal encoded by a Code Division Multiple Access (CDMA) signal (e.g., Walsh code) to provide a CDMA encoded sounding signal. In another example embodiment, the signal may include a sounding signal that includes Is transmitted on one or more resource blocks in an uplink direction, each resource block including a group of subcarriers.

Block 904 may include receiving a sounding signal from at least one of the one or more mobile stations, the sounding signal being received on one or more group(s) of subcarriers in an uplink direction wherein the one or more groups of subcarriers each have a channel quality, as measured by one of the one or more mobile station in a downlink direction, that is greater than or equal to the channel quality threshold.

Block 904 may include receiving comprises receiving a sounding signal from at least one of the one or more mobile stations, the sounding signal being received on one or more group of subcarriers in an uplink direction wherein the one or more groups of subcarriers each have an average channel quality, as measured by one of the one or more mobile station in a downlink direction, that is greater than or equal to the channel quality threshold.

Block 904 may include receiving, at a base station, a sounding signal on one or more groups of subcarriers in an uplink direction from a first mobile station of the one or more mobile stations, the receiving of the sounding signal on one or more groups of subcarriers in an uplink direction from the first mobile station implicitly indicating that one or more signals, transmitted from the base station on the one or more groups of subcarriers in the downlink direction, as measured by the first mobile station, have a channel quality greater than the threshold channel quality.

According to another example embodiment, an apparatus may include a wireless transceiver; and a controller. The apparatus (e.g., controller/processor and wireless transceiver) being configured to: broadcast, in a downlink direction to one or more mobile stations in a wireless network, a message that includes a channel quality threshold; and receive a signal (e.g., sounding signal) from at least one of the one or more mobile stations, the signal being received in an uplink direction on one or more resource blocks that have a channel quality, as measured by one of the one or more mobile station in a downlink direction, that is greater than or equal to the channel quality threshold.

In an example embodiment, the apparatus (e.g., controller or processor and wireless transceiver) may be configured to receive a signal comprises a wireless transceiver being configured to receive a sounding signal from at least one of the one or more mobile stations, the sounding signal being received in an uplink direction on one or more resource blocks that have a channel quality, as measured by one of the one or more mobile station in a downlink direction, that is greater than or equal to the channel quality threshold.

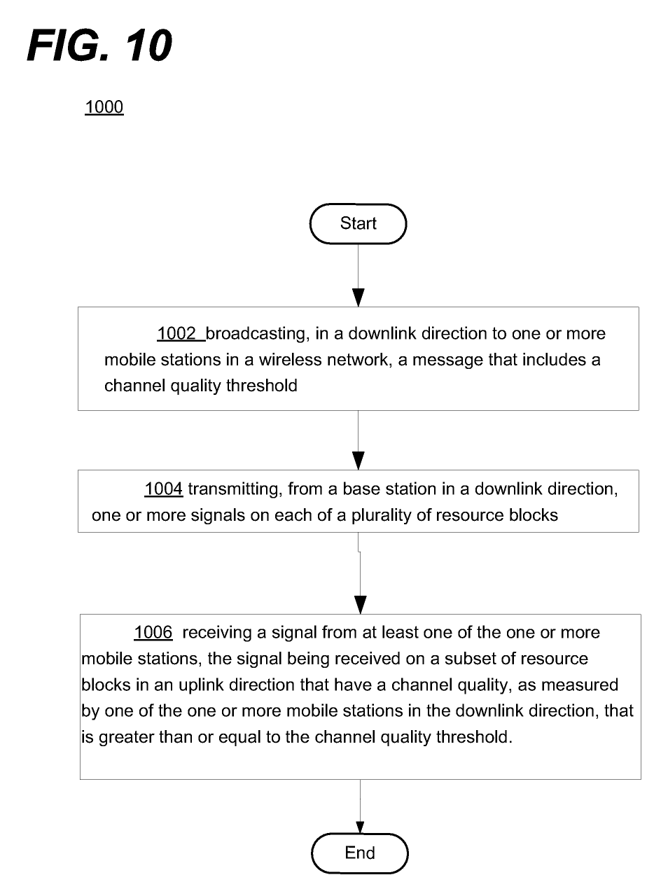

FIG. 10 is a flow chart of an example embodiment of a technique 1000 in accordance with the disclosed subject matter.

Block 1002 may include broadcasting, in a downlink direction to one or more mobile stations in a wireless network, a message that includes a channel quality threshold. Block 1004 may include transmitting, from a base station in a downlink direction, one or more signals on each of a plurality of resource blocks. Operation 1006 may include receiving a signal (e.g., sounding signal) from at least one of the one or more mobile stations, the signal being received on a subset of resource blocks in an uplink direction that have a channel quality, as measured by one of the one or more mobile stations in the downlink direction, that is greater than or equal to the channel quality threshold.

In an example embodiment, block 1004 may include transmitting, from a base station in a downlink direction, one or more signals on each of a plurality of resource blocks, the one or more signals comprises one or more of a preamble, a midamble and a pilot subcarrier signal.

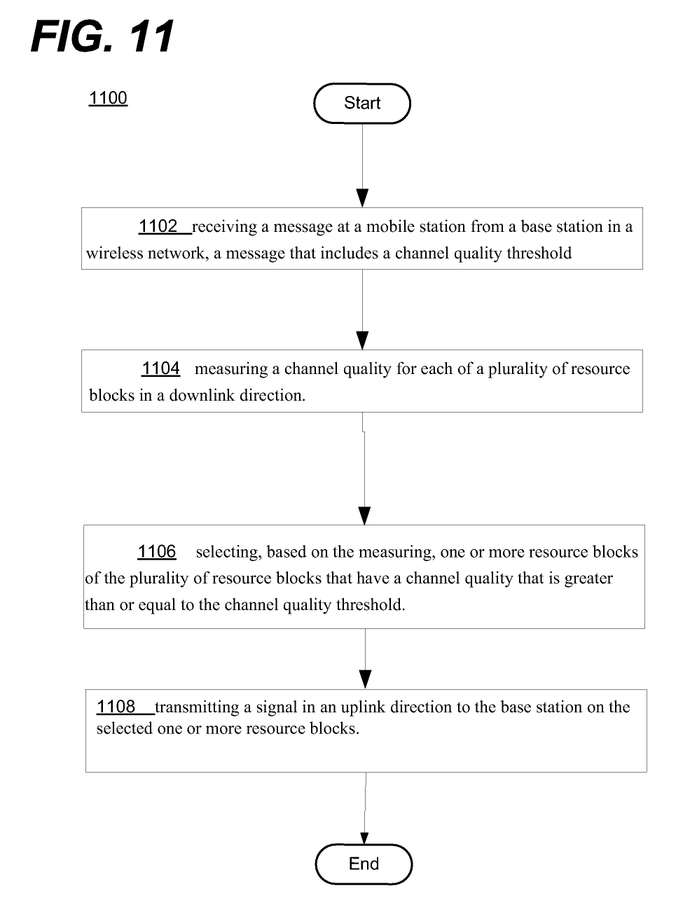

FIG. 11 is a flow chart of an example embodiment of a technique 1100 in accordance with the disclosed subject matter.

Block 1102 may include receiving a message at a mobile station from a base station in a wireless network, a message that includes a channel quality threshold. Block 1104 may include measuring a channel quality for each of a plurality of resource blocks in a downlink direction. Block 1106 may include selecting, based on the measuring, one or more resource blocks of the plurality of resource blocks that have a channel quality that is greater than or equal to the channel quality threshold. Block 1108 may include transmitting a signal in an uplink direction to the base station on the selected one or more resource blocks.

In an example embodiment, block 1108 may include transmitting a sounding signal in an uplink direction to the base station on the selected one or more resource blocks, the sounding signal on the selected one or more resource blocks indicating resource blocks having a channel quality in a downlink direction that is greater than or equal to the channel quality threshold.

Block 1104 may include receiving, at the mobile station from the base station in a downlink direction, one or more signals on each of the plurality of resource blocks, the one or more signals comprising one or more of a preamble, a midamble and a pilot subcarrier signal; and measuring a channel quality of at least one of the one or more received signals on each of the plurality of resource blocks in the downlink direction.

In another example embodiment, block 1104 may include measuring at least one of the following for each of the plurality of resource blocks: signal to noise ratio; signal to interference and noise ratio; received signal strength.

In an example embodiment, each of the resource blocks may include, for example, a group of 18 subcarriers, wherein the measuring a channel quality measurement for each resource block comprises measuring an average channel quality across the 18 subcarriers for each group of subcarriers. 18 is merely an example, and a group may include any number of subcarriers.

According to another example embodiment, an apparatus may include a wireless transceiver, and a controller. In an example embodiment, the apparatus (e.g., controller/processor and wireless transceiver) may be configured to receive a message at a mobile station from a base station in a wireless network, a message that includes a channel quality threshold, measure a channel quality for each of a plurality of resource blocks in a downlink direction. The controller may be configured to select, based on the measuring, one or more resource blocks of the plurality of resource blocks that have a channel quality that is greater than or equal to the channel quality threshold. And, the apparatus may be configured to transmit a signal in an uplink direction to the base station on the selected one or more resource blocks.

In an example embodiment, the apparatus may be configured to transmit a signal comprises the wireless transceiver being configured to transmit a sounding signal in an uplink direction to the base station on the selected one or more resource blocks to thereby indicate that the selected resource blocks, as measured in a downlink direction, have a channel quality that is greater than or equal to the channel quality threshold.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A method comprising:
broadcasting, in a downlink direction to one or more mobile stations in a wireless network, a message that includes a channel quality threshold; and
receiving a signal from at least one of the one or more mobile stations, the signal being received in an uplink direction on one or more resource blocks that have a channel quality, as measured by one of the one or more mobile station in a downlink direction, that is greater than or equal to the channel quality threshold.

2. The method of claim 1 wherein the signal comprises a sounding signal encoded by a Code Division Multiple Access (CDMA) signal to provide a CDMA encoded sounding signal.

3. The method of claim 1 wherein the signal comprises a sounding signal that includes Is transmitted on one or more resource blocks in an uplink direction, each resource block including a group of subcarriers.

4. The method of claim 1 wherein the receiving comprises receiving a sounding signal from at least one of the one or more mobile stations, the sounding signal being received on one or more group of subcarriers in an uplink direction wherein the one or more groups of subcarriers each have a channel quality, as measured by one of the one or more mobile station in a downlink direction, that is greater than or equal to the channel quality threshold.

5. The method of claim 1 wherein the receiving comprises receiving a sounding signal from at least one of the one or more mobile stations, the sounding signal being received on one or more group of subcarriers in an uplink direction wherein the one or more groups of subcarriers each have an average channel quality, as measured by one of the one or more mobile station in a downlink direction, that is greater than or equal to the channel quality threshold.

6. The method of claim 1 wherein the receiving comprises receiving, at a base station, a sounding signal on one or more groups of subcarriers in an uplink direction from a first mobile station of the one or more mobile stations, the receiving of the sounding signal on one or more groups of subcarriers in an uplink direction from the first mobile station implicitly indicating that one or more signals, transmitted from the base station on the one or more groups of subcarriers in the downlink direction, as measured by the first mobile station, have a channel quality greater than the threshold channel quality.

7. An apparatus comprising:
a wireless transceiver; and
a controller;
the apparatus being configured to:
broadcast, in a downlink direction to one or more mobile stations in a wireless network, a message that includes a channel quality threshold; and
receive a signal from at least one of the one or more mobile stations, the signal being received in an uplink direction on one or more resource blocks that have a channel quality, as measured by one of the one or more mobile station in a downlink direction, that is greater than or equal to the channel quality threshold.

8. The apparatus of claim 7 wherein the apparatus being configured to receive a signal comprises a wireless transceiver being configured to receive a sounding signal from at least one of the one or more mobile stations, the sounding signal being received in an uplink direction on one or more resource blocks that have a channel quality, as measured by one of the one or more mobile station in a downlink direction, that is greater than or equal to the channel quality threshold.

9. A method comprising:
broadcasting, in a downlink direction to one or more mobile stations in a wireless network, a message that includes a channel quality threshold;
transmitting, from a base station in a downlink direction, one or more signals on each of a plurality of resource blocks; and
receiving a signal from at least one of the one or more mobile stations, the signal being received on a subset of resource blocks in an uplink direction that have a channel quality, as measured by one of the one or more mobile stations in the downlink direction, that is greater than or equal to the channel quality threshold.

10. The method of claim 9 wherein the transmitting comprises transmitting, from a base station in a downlink direction, one or more signals on each of a plurality of resource blocks, the one or more signals comprises one or more of a preamble, a midamble and a pilot subcarrier signal.

11. A method comprising:
receiving a message at a mobile station from a base station in a wireless network, a message that includes a channel quality threshold;
measuring a channel quality for each of a plurality of resource blocks in a downlink direction;
selecting, based on the measuring, one or more resource blocks of the plurality of resource blocks that have a channel quality that is greater than or equal to the channel quality threshold;
transmitting a signal in an uplink direction to the base station on the selected one or more resource blocks.

12. The method of claim 11 wherein the transmitting a signal comprises transmitting a sounding signal in an uplink direction to the base station on the selected one or more resource blocks, the sounding signal on the selected one or more resource blocks indicating resource blocks having a channel quality in a downlink direction that is greater than or equal to the channel quality threshold.

13. The method of claim 11 wherein the measuring a channel quality comprises:
receiving, at the mobile station from the base station in a downlink direction, one or more signals on each of the plurality of resource blocks, the one or more signals comprising one or more of a preamble, a midamble and a pilot subcarrier signal; and
measuring a channel quality of at least one of the one or more received signals on each of the plurality of resource blocks in the downlink direction.

14. The method of claim 11 wherein the measuring the channel quality comprising measuring at least one of the following for each of the plurality of resource blocks:
signal to noise ratio;
signal to interference and noise ratio;
received signal strength.

15. The method of claim 11 wherein each of the resource blocks comprises a group a subcarriers.

16. The method of claim 11 wherein each of the resource blocks comprises a group of 18 subcarriers, wherein the measuring a channel quality measurement for each resource block comprises measuring an average channel quality across the 18 subcarriers for each group of subcarriers.

17. An apparatus comprising:
a wireless transceiver; and
a controller;
the apparatus being configured to:
receive a message at a mobile station from a base station in a wireless network, a message that includes a channel quality threshold;
measure a channel quality for each of a plurality of resource blocks in a downlink direction;
the controller being configured to select, based on the measuring, one or more resource blocks of the plurality of resource blocks that have a channel quality that is greater than or equal to the channel quality threshold; and
the apparatus being configured to transmit a signal in an uplink direction to the base station on the selected one or more resource blocks.

18. The apparatus of claim 17 wherein the apparatus being configured to transmit a signal comprises the apparatus being configured to transmit a sounding signal in an uplink direction to the base station on the selected one or more resource blocks to thereby indicate that the selected resource blocks, as measured in a downlink direction, have a channel quality that is greater than or equal to the channel quality threshold.

19. A method comprising:
establishing an association between a base station and at least one mobile station (MS) via a communications channel, wherein the communications channel is divided into resource blocks;
broadcasting a channel quality threshold message that includes a channel quality threshold;
receiving at least one channel quality reporting message, respectively from the at least one mobile station(s), each of the channel quality reporting messages including a sounding signal received via one or more of the resource blocks that have a measured channel quality that is greater than or equal to the channel quality threshold.

20. A method comprising:
establishing an association between the base station and at least one mobile station (MS) via a communications channel, wherein the communications channel is divided into resource blocks;
broadcasting a channel quality threshold message that includes a channel quality threshold;
receiving at least one reporting message, respectively from the at least one mobile station(s), indicating which resource blocks have a measured channel quality that is greater than or equal to the channel quality threshold; and
allocating, in a time division multiplexing mode, resource blocks for communication with the mobile station(s) based, at least in part, upon the reporting message(s).

21. The method of claim 20 wherein the receiving comprises receiving a reporting sounding signal via an uplink (UL) resource band on one or more resource blocks that have a measured channel quality, as measured in a downlink direction by the at least one mobile station, that is greater than or equal to the channel quality threshold.

22. The method of claim 20 wherein the reporting message comprises a Code Division Multiple Access (CDMA) encoded sounding signal representing a substantially orthogonal identifier, the CDMA encoded sounded signal being provided on one or more resource blocks having a channel quality measured by the at least one mobile station that is greater than or equal to the channel quality threshold.

23. The method of claim 20 wherein a mobile station includes a plurality of antennas; and
wherein the threshold message causes the mobile station to measure the channel quality of the resource blocks of the communications channel for each antenna of the mobile station and compare with the broadcasting channel quality threshold;

24. The method of claim 20 wherein receiving includes receiving at least one reporting message encoded such that each of the at least one mobile stations is identifiable via a substantially unique orthogonal code.

25. The method of claim 20 wherein receiving includes:
receiving a reporting sounding signal from a transmitting mobile station only if the transmitting mobile station measured at least one resource block with the channel quality greater than or equal to the channel quality threshold.

26. The method of claim 20 wherein receiving includes:
if the transmitting mobile station measured more than a set maximum number of resource blocks with the channel quality that is greater than or equal to the channel quality threshold, receiving a reporting message from the transmitting mobile station including only the set maximum limit of resource blocks with the highest channel quality.

27. The method of claim 20 wherein receiving includes:
receiving a reporting sounding signal that includes an interleaved orthogonal code sequence.

28. The method of claim 20 wherein receiving includes:
receiving a reporting message, via the resource blocks measured by a measuring mobile station to have the channel quality equal to or above the channel quality threshold by the measuring mobile station, that identifies the measuring mobile station.

29. The method of claim 20 further including:
assigning an N-bit (e.g. 8-bit Walsh code) to each antenna of each associated mobile station.

30. A method comprising:
establishing an association between the mobile station and a base station via a communications channel, wherein the communications channel is divided into resource blocks;
receiving, from the base station, a broadcast channel quality threshold message including a channel quality threshold;
measuring a channel quality for each of a plurality of the resource blocks; and
if at least one resource block includes a channel quality that is greater than or equal to the channel quality threshold, transmitting a reporting message, to the base station, indicating which resource block(s) include a channel quality that is greater than or equal to the channel quality threshold.

31. The method of claim 30 wherein transmitting includes:
transmitting the reporting message via only the resource blocks that include a channel quality that is greater than or equal the channel quality threshold value.

32. The method of claim 30 wherein the mobile station includes at least one antenna configured to communicate with the base station; and
wherein transmitting includes transmitting a substantially orthogonal identifier code for each antenna.

33. The method of claim 30 wherein measuring includes:
measuring a signal to noise ration (SNR) for each resource block for each antenna.

34. The method of claim 30 wherein transmitting includes:
interleaving the substantially orthogonal codes for the antennas to form the reporting message.
